(19) United States
(12) Patent Application Publication
(10) Pub. No.: US 2015/0067550 A1
(43) Pub. Date: Mar. 5, 2015

(54) DUAL SCREEN SYSTEM AND METHOD

(71) Applicant: Samsung Electronics Co., Ltd., Gyeonggi-do (KR)

(72) Inventor: Sangmin Shin, Gyeonggi-do (KR)

(21) Appl. No.: 14/476,621

(22) Filed: Sep. 3, 2014

(30) Foreign Application Priority Data
Sep. 3, 2013 (KR) 10-2013-0105175

(51) Int. Cl. G06F 3/0481; G06F 3/0488

(52) U.S. Cl. CPC G06F 3/0481; G06F 3/0488
USPC 715/761

(57) ABSTRACT

A method for dual screen presentation, using a touch screen of a terminal and a screen of a computing device includes recognizing a connection between the mobile terminal and the computing device, detecting an application program window moving into a scope of a screen of the mobile terminal from a scope of a screen of the computing device, and displaying the application program window on a touch screen of the mobile terminal. A mobile terminal includes a transceiver configured to communicate data with a computing device, a touch screen configured to display an image or a video, and a controller configured to detect an application program window moving into a scope of a screen of the mobile terminal from a scope of a screen of the computing device, and cause the touch screen to display the application program window. Other embodiments including a computing device are also disclosed.

### CROSS-REFERENCE TO RELATED APPLICATION AND CLAIM OF PRIORITY

The present application is related to and claims priority from and the benefit under 35 U.S.C. §119(a) of Korean Patent Application No. 10-2013-0105175, filed on Sep. 3, 2013, which is hereby incorporated by reference for all purposes as if fully set forth herein.

### TECHNICAL FIELD

The present disclosure relates generally to a dual monitor system and method, and more particularly to a dual monitor system and method using a terminal including a touch screen and a computing device including a screen.

### BACKGROUND

Electronic devices including recently developed computers can provide users with various functions by executing application programs through processors. As various application programs have been developed and specifications of electronic devices have been improved, the electronic device can simultaneously perform several tasks and connect a main body of the electronic device to two or more screens to meet a multitasking environment, so as to support a dual monitoring mode in which respective task environments are displayed.

Meanwhile, various terminals are used as electronic devices which can be carried by users today. According to the development of technologies, the electronic devices in a comprehensive multimedia device type having complex functions such as not only a voice call but also a video call, taking a picture or a video, reproducing music and a video file, receiving a broadcast, playing a game and wireless Internet and the like are released. Specifications of a processor installed in the terminal are being improved at an alarming rate and terminals which provide light and large screens within a portable range are being developed. Further, a terminal including a touch screen is currently provided to increase the interface convenience of the user.

A portable terminal and a computing device provided to process various tasks in a fixed location may provide the user with different functions as necessary. Accordingly, the user may require simultaneously use of the terminal and the computing device, but it is inconvenient for the user to separately control the terminal and the computing device.

Therefore, a method of supporting a dual monitoring mode of the computing device through interworking between the terminal and the computing device and also executing a function of the terminal is required.

### SUMMARY

A method for dual screen presentation, using a touch screen of a terminal and a screen of a computing device includes recognizing a connection between the mobile terminal and the computing device, detecting an application program window moving into a scope of a screen of the mobile terminal from a scope of a screen of the computing device, and displaying the application program window on a touch screen of the mobile terminal.

In some embodiments, the method further includes detecting a pointer moving from the scope of the screen of the mobile terminal onto the scope of the screen of the computing device; and transmitting the pointer to the computing device, where the screen of the computing device displays the pointer.

In some embodiments, the method further includes moving a user interface of the mobile terminal onto the screen of the computing device.

In some embodiments, a function of the mobile terminal is provided through the user interface of the terminal which is copied to the screen of the computing device.

In some embodiments, the terminal is attached to one side of the screen of the computing device.

In some embodiments, when the connection between the terminal and the computing device is recognized, functions of the computing device and the terminal are controlled by a user input means of the computing device.

In some embodiments, moving the predetermined application program window comprises, when the predetermined application program window is moved in a preset direction by a predetermined distance or more, moving the predetermined application program window to the touch screen of the terminal from the screen of the computing device.

In some embodiments, the method further includes moving the user interface of the terminal which is copied to the screen of the computing device to the touch screen of the terminal in response to the user input.

In some embodiments, the moving of the user interface comprises, when an application program window executed by the computing device exists on the touch screen of the terminal, blocking movement of the copied user interface to the touch screen of the terminal.

In some embodiments, when the user interface of the terminal which is copied to the screen of the computing device is moved to the touch screen of the terminal in response to the user input, an application program window, which is executed on the touch screen of the terminal by the computing device, is generated on the screen of the computing device.

A mobile terminal includes a transceiver configured to communicate data with a computing device, a touch screen configured to display an image or a video, and a controller configured to detect an application program window moving into a scope of a screen of the mobile terminal from a scope of a screen of the computing device, and cause the touch screen to display the application program window.

A computing device for dual screen presentation includes a transceiver configured to communicate data with a mobile terminal, a screen configured to display an image or a video, and a controller configured to receive a user interface of the mobile terminal from the mobile screen, and cause the screen to display the user interface.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate a dual monitoring system according to an embodiment of the present disclosure;

FIG. 2 illustrates a detailed embodiment of the terminal of FIGS. 1A and 1B;

FIG. 3 illustrates a detailed embodiment of the computing device of FIGS. 1A and 1B;

FIGS. 4A to 4C illustrate a method in which a dual monitoring system switches a dual monitor mode according to an embodiment of the present disclosure;

FIG. 5A illustrates an example of a dual monitor system in a single monitor mode according to an embodiment of the present disclosure;

FIG. 5B illustrates an example of a dual monitor system in a dual monitor mode according to an embodiment of the present disclosure;

FIGS. 6A to 6C illustrate a method in which a dual monitor system ends a dual monitor mode according to an embodiment of the present disclosure; and

FIG. 7 is a flowchart illustrating a dual monitor method according to an embodiment of the present disclosure.

### DETAILED DESCRIPTION

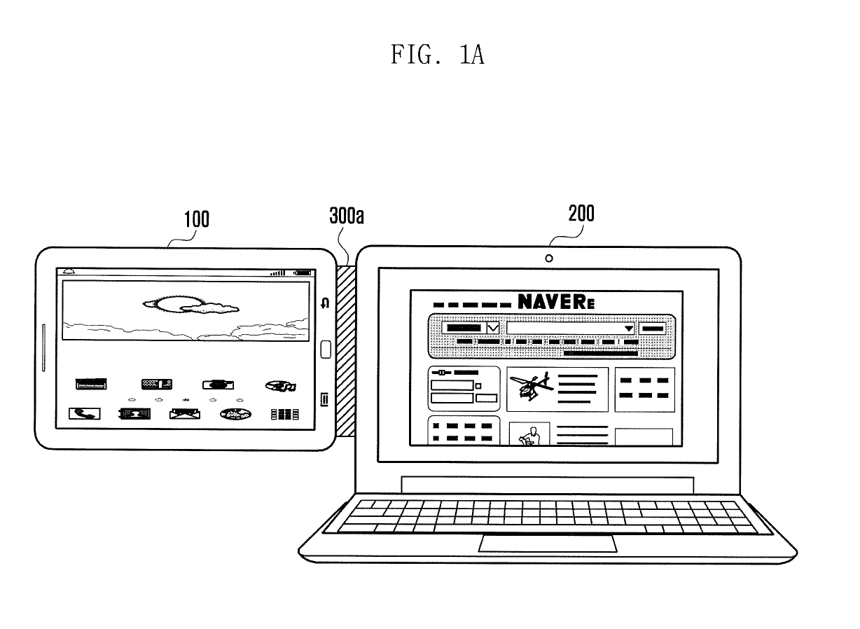

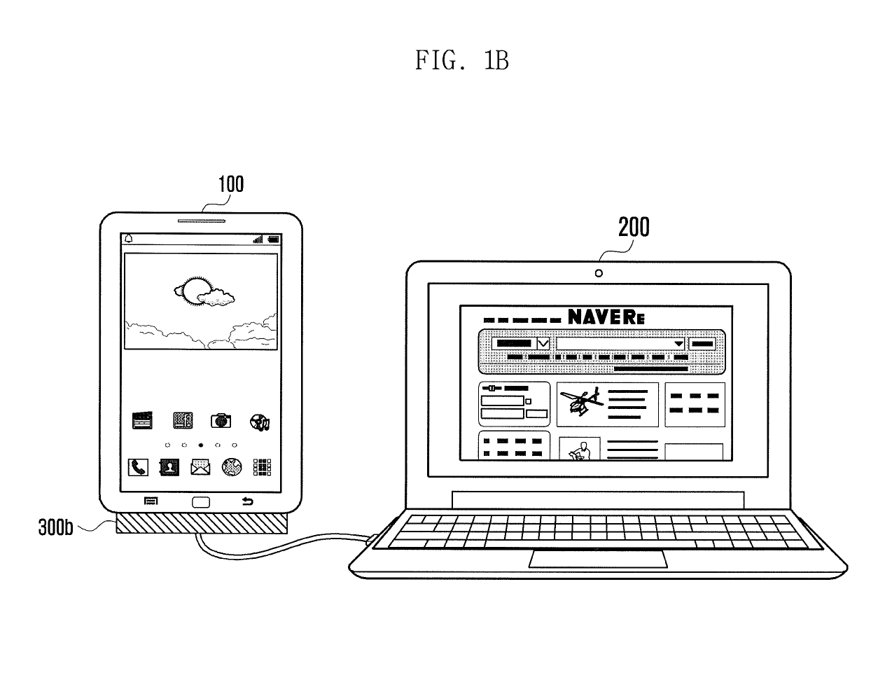

FIGURES 1A through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, exemplary embodiments of the present disclosure will be described with reference to the accompanying drawings. It is noted that, where possible, the same reference numerals are designated to the same components in the accompanying drawings. Further, a detailed description of a known function and configuration which may make the subject matter of the present disclosure unclear will be omitted.

Prior to the detailed description through embodiments, a computing device described in the specification and drawings may include all electronic devices which provide a user with various functions by executing application programs through a process stored in a memory.

A “dual monitor mode” used in the specification and drawings refers to a case where a task environment of an application program executed by the computing device is implemented on not only a screen of the computing device but also a touch screen of a terminal connected to the computing device. That is, the “dual monitor mode” refers to a case where the touch screen of the terminal operates as an additional screen of the computing device.

A “single monitor mode” described in the specification and drawings refers to a case where functions of the terminal and the computing device executed by corresponding processors are independently displayed on respective screens in a state where the terminal and the computing device are connected to each other. That is, the “single monitor mode” refers to a case where a task environment of the terminal is implemented on the touch screen of the terminal and a task environment of the computing device is implemented on the screen of the computing device.

FIGS. 1A and 1B illustrate a dual monitor system according to an embodiment of the present disclosure.

The dual monitor system includes a terminal 100 and a computing device 200 as illustrated in FIGS. 1A and 1B. The terminal 100 can include a touch screen and display a user interface on the touch screen. The computing device 200 can include a screen and display an application program window executed by the computing device on the screen. The terminal 100 and the computing device 200 are executed by processors stored in respective memories thereof.

A dual monitor system connects the terminal 100 and the computing device 200 to allow the terminal 100 and the computing device 200 to exchange signals. The terminal 100 and the computing device 200 can be connected to each other through a wire or wirelessly connected to each other by using a wireless network. Meanwhile, a connection device 300a for connecting one side of the terminal 100 and one side of the screen of the computing device 200 can be further included as illustrated in FIG. 1A, or a connection device 300b for fixing the terminal 100 and connecting the terminal 100 to the computing device 200 can be further included for convenience of the user. Embodiments of the present disclosure include all methods of disposing the terminal 100 and the computing device 200 such that the user can have secured view for the touch screen of the terminal 100 and the screen of the computing device 200 can be secured.

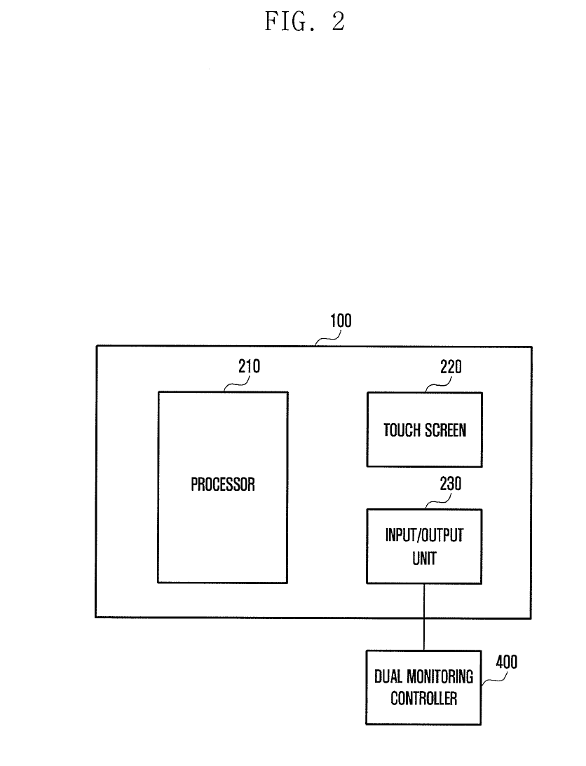

FIG. 2 illustrates a detailed embodiment of the terminal 100 according to an embodiment of the present disclosure.

The terminal 100 can include a processor 210, a touch screen 220, and an input/output unit 230. The processor 210 can control general operations of the terminal 100. That is, the processor 210 can perform a function of providing a user interface to the touch screen 220, receiving a user input through the user interface, and executing a corresponding application program. The processor can receive a user input through the touch screen 220 and also receive a user input through the input/output unit 230.

The touch screen 220 can receive a touch input by the user and also receive an output signal from the processor 210 or the input/output unit 230 and display an output screen. That is, the touch screen 220 can display a user interface and an executed application program and the displayed user interface and application program can be intuitively controlled by a touch input on the touch screen 220 by the user.

The input/output unit 230 is provided to connect the terminal 100 and an external device, for example, the computing device 200. When the input/output unit 230 is connected to the computing device 200, an output signal of the processor 210 can be transmitted to the screen of the computing device 200, a user input signal by the computing device 200 can be transmitted to the processor 210 of the terminal 100, and an output signal of the computing device 200 can be transmitted to the touch screen 230 of the terminal 100.

The dual monitor system according to the embodiment of the present disclosure can include a dual monitor controller 400 for operating the terminal 100 and the computing device 200 in a dual monitor mode. The dual monitor controller 400 is connected to the terminal 100 and the computing device 200 to control switching to the dual monitor mode or the single monitor mode. At this time, the dual monitor controller 400 can be located outside the terminal 100 as illustrated in FIG. 2, but can be located inside the terminal 100. A dual monitor controller 400 which will be described below can be located inside the computing device 200. That is, the dual monitor controller 400 should be interpreted based on the function of the configuration rather than an arrangement of the configuration in the present disclosure.

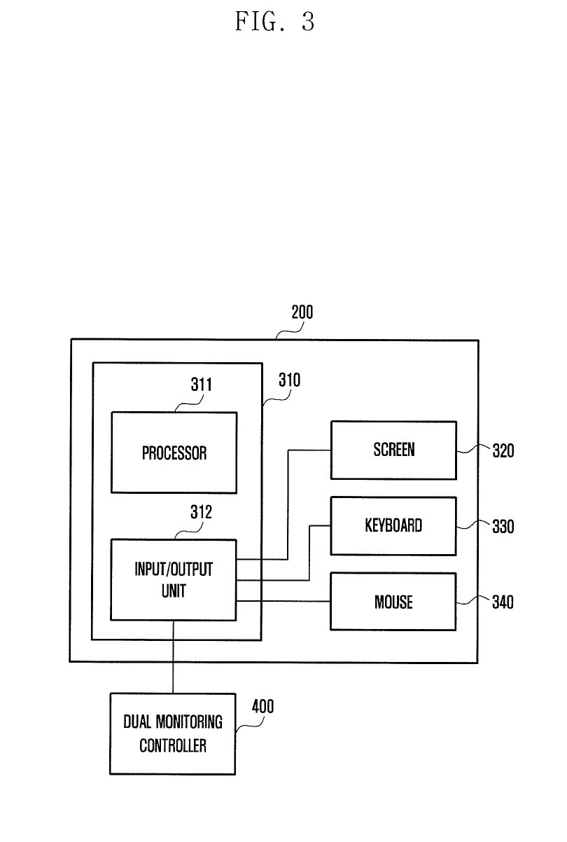

FIG. 3 illustrates a detailed embodiment of the computing device 200 according to an embodiment of the present disclosure.

The computing device 200 can include a main body 310 and peripherals 320 to 340. The main body can include a processor 311 for controlling general operations of the computing device 200 and an input/output unit 312 provided to connect the peripherals 320 to 340 and the terminal 100.

A screen 320, a keyboard 330, and a mouse 340 transmit/receive signals through the input/output unit 312. The screen 320 can receive an output signal of the processor 311 and an output signal of the terminal 100 through the input/output unit 312 and display an output screen. The keyboard 330 and the mouse 340 are user input means and input signals input by the keyboard 330 and the mouse 340 can be transmitted to the processor 311 and the terminal 100 through the input/output unit 312.

The dual monitor controller 400 is connected to the terminal 100 and the computing device 200 to control switching to the dual monitor mode or the single monitor mode. The dual monitor controller 440 can be located outside or inside the computing device 200 as described above.

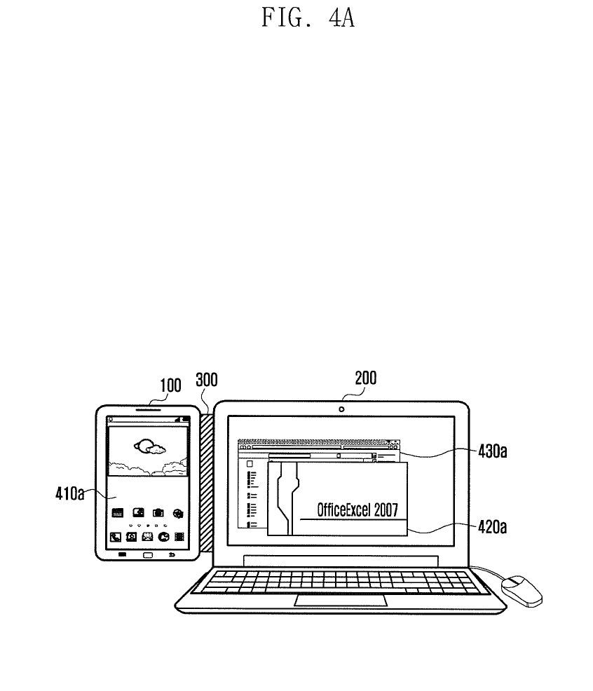

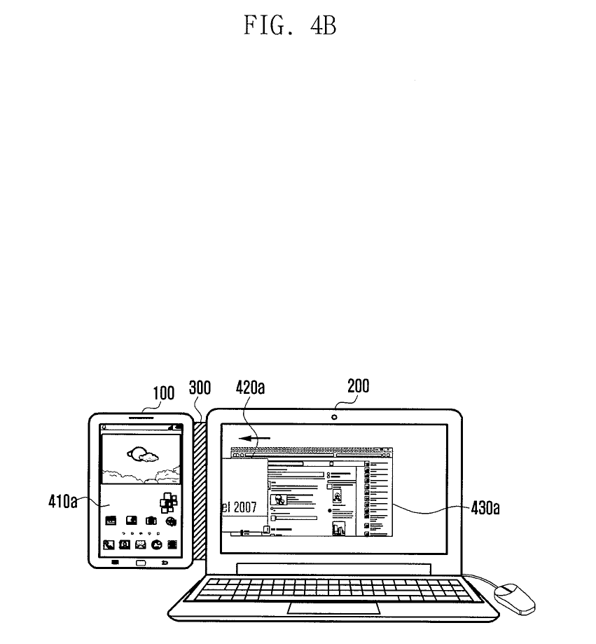

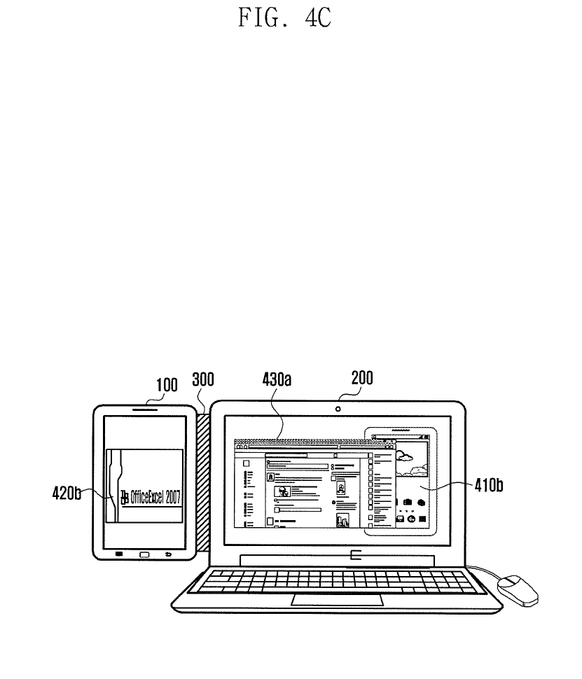

FIGS. 4A to 4C illustrate that a dual monitor system operates in the dual monitor mode according to an embodiment of the present disclosure. Referring to FIG. 4A, the terminal 100 and the computing device 200 are connected through a wire or wirelessly, using any suitable communication technologies including cellular, Wifi, Bluetooth, and Near Field Technologies (NFC). In some embodiments, the terminal 100 and the computing device 200 are attached to each other by a connection device 300.

Each of the terminal 100 and the computing device 200 operates in the single monitor mode. The terminal 100 displays a user interface 410a on the touch screen. The computing device 200 displays one or more application program windows 420a and 430a being executed on the screen.

Thereafter, as illustrated in FIG. 4B, the application program window 420a displayed on the screen of the computing device 200 is dragged using a mouse connected to the computing device 200 and moved in a direction in which the terminal 100 is located by a predetermined distance. At this time, the direction in which the terminal 100 is located can be preset by the user. When the application program window 420a is dragged by a threshold or more, switching to the dual monitor mode is made as illustrated in FIG. 4C. That is, the dragged application program window 420 disappears from the screen of the computing device 200 and the application program window 420b is generated on the touch screen of the terminal 100. That is, the touch screen of the terminal 100 operates as one of a dual screen of the computing device 200. Meanwhile, a user interface 410b of the terminal 100 is copied to the screen of the computing device 200. Accordingly, even in the dual monitor mode, the user can execute a function of the terminal 100 through the user interface 410b of the terminal 100 copied to the screen of the computing device 200.

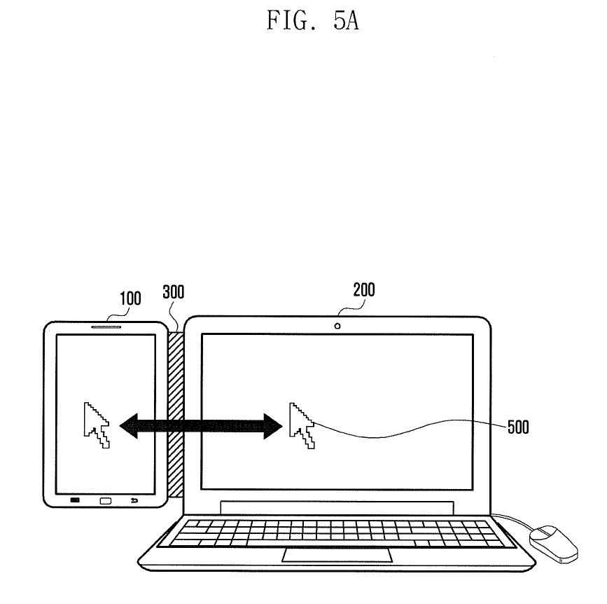

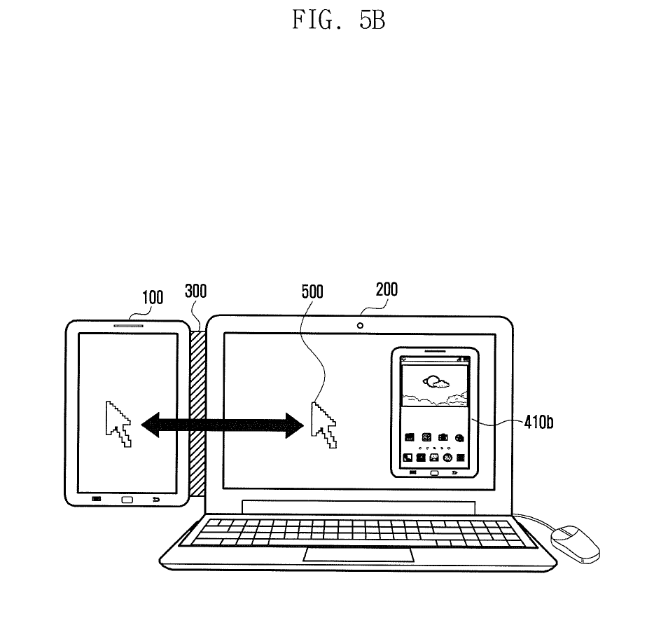

Referring to FIG. 5A, when the dual monitor system is in the single monitor mode, a mouse cursor 500 can move on the screen of the computing device 200 and the touch screen of the terminal 100 through a control of the mouse by the user. That is, in the single monitor mode, through a mouse and a keyboard corresponding to input means connected to the computing device 200, a function of the terminal 100 can be executed on the screen of the terminal 100 or a function of the computing device 200 can be executed on the screen of the computing device 200.

Referring to FIG. 5B, when the dual monitor system is in the dual monitor mode, the touch screen of the terminal 100 operates as one of the dual screen of the computing device 200. That is, the mouse cursor 500 can move on the touch screen of the terminal 100 as well as on the screen of the computing device 200, so as to control the application program window executed by the computing device 200. Further, the user interface 410b of the terminal 100 is copied to the screen of the computing device 200. The user can execute the function of the terminal 100 through the copied user interface 410b. That is, in the dual monitor mode, through the mouse and the keyboard corresponding to the input means connected to the computing device 200, the application program window executed by the computing device 200 can be controlled on both the touch screen of the terminal and the screen of the computing device 200 and the function of the terminal 100 can be executed on the copied user interface 410b.

Meanwhile, according to an embodiment of the present disclosure, since the terminal 100 and the computing device 200 are connected to each other, a file displayed on the touch screen of the terminal 100 can be copied to the computing device 200 by dragging the file through a mouse cursor 500 and a file displayed on the screen of the computing device 200 can be copied to the terminal 100 by dragging the file.

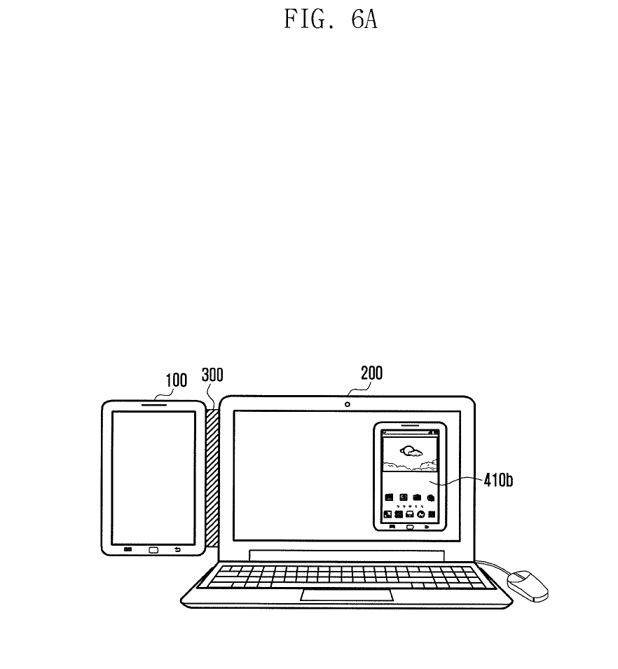

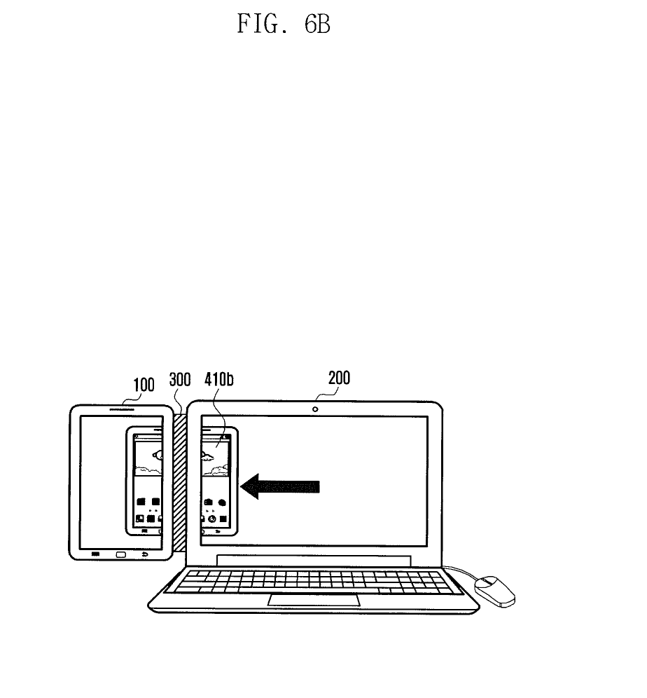

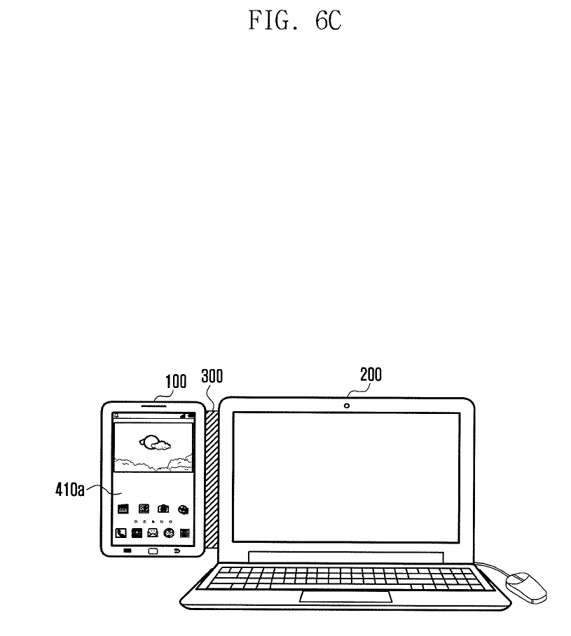

FIGS. 6A to 6C illustrate a method in which a dual monitor system ends a dual monitor mode according to an embodiment of the present disclosure.

Referring to FIG. 6A, the dual monitor system is in a state where the dual monitor mode is operated. That is, the terminal 100 is connected to the computing device 200 and the touch screen of the terminal 100 operates as one of the dual screen of the computing device 200. The user interface 410b of the terminal 100 is copied to the screen of the computing device 200.

Thereafter, as illustrated in FIG. 6B, the user interface 410b of the terminal 100 copied to the screen of the computing device 200 is moved to the terminal 100. For example, the copied user interface 410b can be dragged using a mouse. Since the touch screen of the terminal 100 and the screen of the computing device 200 operate in the dual monitor mode, the copied user interface 410b can be moved to the touch screen of the terminal 100 according to the drag. According to an embodiment, only when an application program window executed by the computing device 200 does not exist on the touch screen of the terminal 100, the movement of the copied user interface 410 to the touch screen of the terminal 100 is allowed. That is, when the touch screen of the terminal 100 displays a function actually executed by the computing device 200 in the dual monitor mode, it can be preset to not end the dual monitor mode.

Alternatively, according to another embodiment, when an application program window executed by the computing device 200 is displayed on the touch screen of the terminal 100, if the copied user interface 410 is moved to the touch screen of the terminal 100, the corresponding application program window can be displayed on the screen of the computing device 200.

As illustrated in FIG. 6C, when the user interface 410a reaches the terminal 100, the dual monitor mode ends. That is, each of the touch screen of the terminal 100 and the screen of the computing device 200 operates in the single monitor mode.

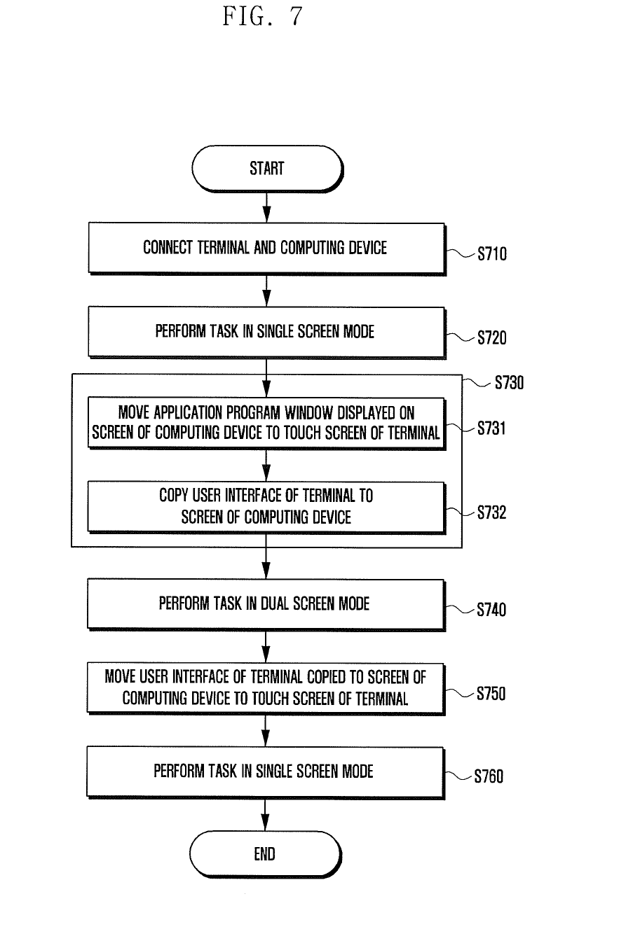

FIG. 7 is a flowchart illustrating a dual monitor method according to an embodiment of the present disclosure.

The dual monitor method illustrated in FIG. 7 will be described below with reference to FIGS. 4 and 6.

First, the terminal 100 and the computing device 200 are connected to each other in step S710. Each of the connected terminal 100 and computing device 200 performs a task in the single monitor mode in step S720. That is, the terminal 100 provides a user interface through the touch screen of the terminal 100 and the computing device 200 provides an application program window through the screen of the computing device 200.

In step S730, the terminal 100 and the computing device 200 are switched to the dual monitor mode. Specifically, when the application program window 420a displayed on the screen of the computing device 200 is moved to the touch screen of the terminal 100 in step S731, the user interface 410b of the terminal 100 is copied to the screen of the computing device 200 in step S732. Thereafter, in step S740, the terminal 100 and the computing device 200 perform tasks in the dual monitoring mode.

In step S750, the terminal 100 and the computing device 200 end the dual monitor mode. Specifically, the user interface 410b copied to the screen of the computing device 200 is moved to the touch screen of the terminal 100. Thereafter, in step S760, the terminal 100 and the computing device 200 perform tasks in the single monitor mode.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for dual screen presentation, using a touch screen of a terminal and a screen of a computing device, the method comprising:
recognizing a connection between the mobile terminal and the computing device;
detecting an application program window moving into a scope of a screen of the mobile terminal from a scope of a screen of the computing device; and
displaying the application program window on a touch screen of the mobile terminal.

2. The method of claim 1, further comprising:
detecting a pointer moving from the scope of the screen of the mobile terminal onto the scope of the screen of the computing device; and
transmitting the pointer to the computing device, where the screen of the computing device displays the pointer.

3. The method of claim 2, further comprising:
moving a user interface of the mobile terminal onto the screen of the computing device.

4. The method of claim 1, wherein a function of the mobile terminal is provided through the user interface of the terminal which is copied to the screen of the computing device.

5. The method of claim 1, wherein the terminal is attached to one side of the screen of the computing device.

6. The method of claim 1, wherein, when the connection between the terminal and the computing device is recognized, functions of the computing device and the terminal are controlled by a user input means of the computing device.

7. The method of claim 1, wherein moving the predetermined application program window comprises, when the predetermined application program window is moved in a preset direction by a predetermined distance or more, moving the predetermined application program window to the touch screen of the terminal from the screen of the computing device.

8. The method of claim 1, further comprising moving a user interface of the terminal which is copied to the screen of the computing device to the touch screen of the terminal in response to a user input.

9. The method of claim 8, wherein the moving of the user interface comprises, when an application program window executed by the computing device exists on the touch screen of the terminal, blocking movement of the copied user interface to the touch screen of the terminal.

10. The method of claim 8, wherein, when the user interface of the terminal which is copied to the screen of the computing device is moved to the touch screen of the terminal in response to the user input, an application program window, which is executed on the touch screen of the terminal by the computing device, is generated on the screen of the computing device.

11. A mobile terminal, comprising:
a transciever configured to communicate data with a computing device;
a touch screen configured to display an image or a video; and
a controller configured to:
detect an application program window moving into a scope of a screen of the mobile terminal from a scope of a screen of the computing device; and
cause the touch screen to display the application program window.

12. The mobile terminal of claim 11, wherein the controller is configured to:
detect a pointer moving from the scope of the screen of the mobile terminal onto the scope of the screen of the computing device; and
transmit the pointer to the computing device, where the screen of the computing device displays the pointer.

13. The mobile terminal of claim 11, wherein the controller is configured to move a user interface of the mobile terminal onto the screen of the computing device.

14. The mobile terminal of claim 11, wherein the terminal is attached to one side of the screen of the computing device.

15. The mobile terminal of claim 11, wherein functions of the computing device and the terminal are controlled by a user input means of the computing device.

16. The mobile terminal of claim 11, wherein, when the application program window displayed on the screen of the computing device is dragged in a preset direction by a predetermined distance or more, the controller is configured to move the application program window to the touch screen of the terminal from the screen of the computing device.

17. The mobile terminal of claim 11, wherein the controller is configured to move a user interface of the terminal which is copied to the screen of the computing device to the touch screen of the terminal in response to a user input.

18. The mobile terminal of claim 17, wherein, when an application program window executed by the computing device exists on the touch screen of the terminal, the controller is configured to block movement of the copied user interface to the touch screen of the terminal.

19. The mobile terminal of claim 17, wherein, when the user interface of the terminal which is copied to the screen of the computing device is moved to the touch screen of the terminal in response to the user input, the dual monitoring controller generates an application program window, which is executed on the touch screen of the terminal by the computing device, on the screen of the computing device.

20. A computing device for dual screen presentation, comprising:
a transceiver configured to communicate data with a mobile terminal;
a screen configured to display an image or a video; and
a controller configured to:
receive a user interface of the mobile terminal from the mobile screen; and
cause the screen to display the user interface.
